(19) United States
(12) Patent Application Publication
(10) Pub. No.: US 2026/0099897 A1
(43) Pub. Date: Apr. 9, 2026

(54) THREE-DIMENSIONAL ROTATION OF TWO-DIMENSIONAL VECTOR GRAPHICS UTILIZING DIFFUSION MODELS

(71) Applicant: Adobe Inc., San Jose, CA (US)

(72) Inventors: Zhiqin Chen, Seattle, WA (US); Matthew Fisher, San Francisco, CA (US); Siddhartha Chaudhuri, New Haven, CT (US)

(21) Appl. No.: 18/910,734

(22) Filed: Oct. 9, 2024

(51) Int. Cl. G06T 3/60; G06F 3/04845; G06T 5/50; G06T 5/60; G06T 5/70; G06T 11/60

(52) U.S. Cl. CPC G06T 3/60; G06F 3/04845; G06T 5/50; G06T 5/60; G06T 5/70; G06T 11/60; G06T 2200/24; G06T 2207/20084; G06T 2210/22

(57) ABSTRACT

The present disclosure relates to systems, non-transitory computer-readable media, and methods for three-dimensional rotation of vector graphics. In particular, in some embodiments, the disclosed systems provide, for display via a graphical user interface of a client device, a two-dimensional vector graphic in a first orientation. In addition, in some embodiments, the disclosed systems receive a user input to rotate the two-dimensional vector graphic in a three-dimensional space to a second orientation. Moreover, in some embodiments, the disclosed systems generate, utilizing a diffusion neural network, a new two-dimensional graphic depicting the two-dimensional vector graphic rotated according to the user input. Furthermore, in some embodiments, the disclosed systems provide, for display via the graphical user interface, the new two-dimensional graphic in the second orientation.

### BACKGROUND

Recent years have seen developments in hardware and software platforms implementing generative models for image synthesis. For example, existing image synthesis systems generate synthetic images based on prompts indicating desired features of an output image. To illustrate, existing systems use image generation models to generate images having a desired object and/or style. Despite these developments, existing systems suffer from a number of technical deficiencies, including inflexibility, inaccuracy, and inefficiency.

### BRIEF SUMMARY

Embodiments of the present disclosure provide benefits and/or solve one or more problems in the art with systems, non-transitory computer-readable media, and methods for providing the rotation of two-dimensional vector graphics in three-dimensional space utilizing new view synthesis via diffusion models. To illustrate, in some embodiments, the disclosed systems provide a two-dimensional vector graphic of an object in a first orientation for display via a graphical user interface. In addition, in some embodiments, the disclosed systems receive a user input to rotate the object in three-dimensional space to a second orientation. Moreover, in some implementations, the disclosed systems use a media generation model, such as a diffusion neural network, to generate a new two-dimensional graphic depicting the object rotated into the second orientation.

To further illustrate, in some implementations, the disclosed systems concatenate a rasterized image of the initial two-dimensional vector graphic with a noised image in a height dimension. In some embodiments, the disclosed systems process the concatenated image through the diffusion neural network to generate the new two-dimensional graphic. Moreover, in some embodiments, the disclosed systems train the media generation model using albedo-only renderings of three-dimensional shapes. Furthermore, in some cases, the disclosed systems fine-tune the media generation model using distribution matching distillation, thereby enhancing the speed of the graphics generation process.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a graphics rotation system operates in accordance with one or more embodiments.

FIG. 2 illustrates the graphics rotation system generating a new two-dimensional graphic based on a user input to rotate an object in accordance with one or more embodiments.

FIGS. 3A-3C illustrate the graphics rotation system generating rotated two-dimensional graphics for display via a graphical user interface in accordance with one or more embodiments.

FIG. 4 illustrates the graphics rotation system concatenating a rasterized image of a two-dimensional vector graphic with a noised image in a height dimension and processing the concatenated image through a diffusion neural network in accordance with one or more embodiments.

FIG. 5 illustrates the graphics rotation system training a diffusion neural network using albedo-only images in accordance with one or more embodiments.

FIG. 6 illustrates a distribution matching distillation process to train a diffusion neural network in accordance with one or more embodiments.

FIG. 7 illustrates an example of a guided diffusion model in accordance with one or more embodiments.

FIG. 8 illustrates an example of a U-Net in accordance with one or more embodiments.

FIG. 9 illustrates an example method for conditional media generation in accordance with one or more embodiments.

FIG. 10 illustrates a diffusion process in accordance with one or more embodiments.

FIG. 11 illustrates a flow diagram depicting an algorithm as a step-by-step procedure for training a machine-learning model in accordance with one or more embodiments.

FIG. 12 illustrates an example method for training a diffusion model in accordance with one or more embodiments.

FIG. 13 illustrates an example computing device in accordance with one or more embodiments.

FIG. 14 illustrates a diagram of an example architecture of the graphics rotation system in accordance with one or more embodiments.

FIG. 15 illustrates a flowchart of a series of acts for generating rotated views of two-dimensional graphics in accordance with one or more embodiments.

FIG. 16 illustrates a block diagram of an example computing device for implementing one or more embodiments of the present disclosure.

### DETAILED DESCRIPTION

This disclosure describes one or more embodiments of a graphics rotation system that generates three-dimensionally rotated views of two-dimensional vector graphics utilizing deep learning and generative artificial intelligence. For example, in some embodiments, the graphics rotation system provides a user interface for rotating two-dimensional vector graphics as if they were three-dimensional models. To illustrate, the graphics rotation system provides a two-dimensional vector graphic of an object or scene in a first orientation for display via a graphical user interface. In addition, the graphics rotation system receives a user input to rotate the object in three-dimensional space to a second orientation. Based on the user input, the graphics rotation system uses a media generation model, such as a diffusion neural network, to generate a new two-dimensional graphic depicting the object rotated into the second orientation. Moreover, the new two-dimensional graphic preserves the details of the original two-dimensional vector graphic, as well as its artistic style. For instance, the graphics rotation system generates the new two-dimensional graphic including details that would naturally appear in the new view of the object, but that are obscured from view in the initial two-dimensional vector graphic.

To further illustrate, in some cases, a graphic artist creates vector art in one orientation, but seeks to rotate the vector art to new views from different perspectives. The graphics rotation system provides an interface to seamlessly input a rotation command and generate a new view of the vector art rotated according to the user input. For instance, the original vector art may be drawn in a front viewpoint, while the graphics rotation system rotates the vector art to a more complex viewpoint, such as an isometric view. Although various details in the new view are not visible in the original view, the graphics rotation system capably generates and adds these details to the vector graphic utilizing a trained media generation model.

In some embodiments, the graphics rotation system vectorizes the new two-dimensional graphic to generate a new two-dimensional vector graphic. Thus, the graphics rotation system provides new vector graphics that are readily manipulated (e.g., resizing, coloring, etc.) in vector graphic scenes. Moreover, in some embodiments, the graphics rotation system generates new views of entire scenes (e.g., with multiple vector graphics) rotated according to a user input.

As described in detail below, in some implementations, the graphics rotation system generates new vector graphics by first generating a vertically concatenated input image for a diffusion neural network. To illustrate, the graphics rotation system concatenates a rasterized image of the initial two-dimensional vector graphic with a noised image in a height dimension. The graphics rotation system uses the rasterized image of the two-dimensional vector graphic and the user input to condition a diffusion process to generate the new two-dimensional graphic.

Additionally, in some embodiments, the graphics rotation system trains the diffusion neural network using albedo-only renderings of three-dimensional models. For example, the graphics rotation system accesses albedo-only views to train the diffusion neural network to generate two-dimensional graphics that are readily vectorizable into vector graphics. Furthermore, in some cases, the graphics rotation system trains the media generation model using distribution matching distillation, thereby enhancing the speed of the graphics generation process.

Although existing systems generate objects, such systems have a number of problems in relation to accuracy and efficiency. For instance, existing systems struggle to generate graphics that are readily vectorizable into two-dimensional vector graphics. For example, existing systems often are tailored to raster images, thus generating images that are not suited for vector graphic generation and manipulation.

Additionally, existing systems often consume excessive time, memory, and computational resources when generating new digital images. For example, existing systems often require numerous iterations of a denoising process to generate a new image. Such iterations are often costly in terms of computing time, bandwidth use, and data storage.

The graphics rotation system outperforms existing systems by generating higher-quality vector graphics and by speeding up inference time. In particular, by concatenating a rasterized image of an initial vector graphic with a noised image in the height dimension, the graphics rotation system generates better rotated views of a vector graphic than those of existing systems. Moreover, by training the diffusion neural network on albedo-only renderings of three-dimensional shapes, the graphics rotation system provides enhanced vector-graphic-like views of objects. Additionally, by using distribution matching distillation to train or fine-tune the diffusion neural network, the graphics rotation system markedly improves the inference speed of image generation over existing systems.

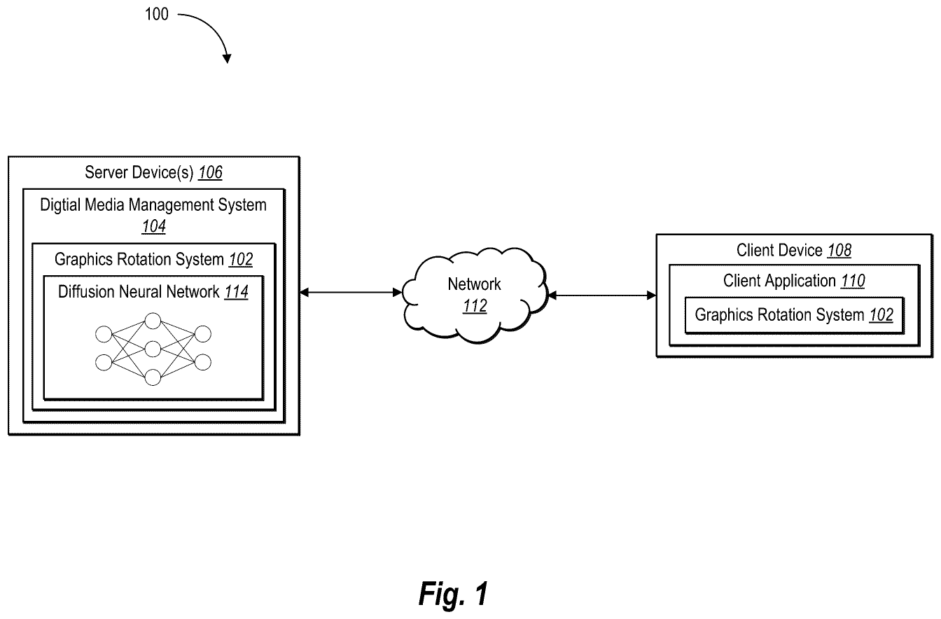

Additional detail will now be provided in relation to illustrative figures portraying example embodiments and implementations of a graphics rotation system. For example, FIG. 1 illustrates a system 100 (or environment) in which a graphics rotation system 102 operates in accordance with one or more embodiments. As illustrated, the system 100 includes server device(s) 106, a network 112, and a client device 108. As further illustrated, the server device(s) 106 and the client device 108 communicate with one another via the network 112.

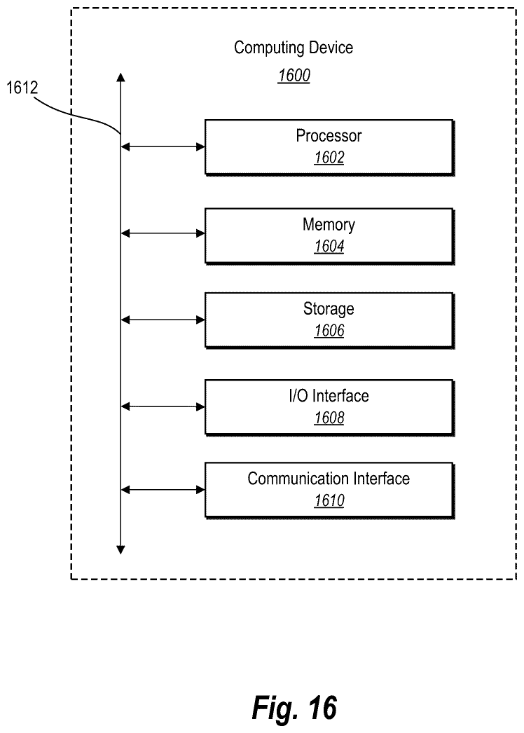

As shown in FIG. 1, the server device(s) 106 includes a digital media management system 104 that further includes the graphics rotation system 102. In some embodiments, the graphics rotation system 102 utilizes one or more machine learning models (e.g., a media generation model, such as a diffusion neural network 114) to generate two-dimensional graphics depicting two-dimensional objects rotated through three-dimensional space. For example, in some implementations, the graphics rotation system 102 utilizes the machine learning models to generate a new two-dimensional graphic depicting a two-dimensional vector graphic rotated according to a user input to rotate the two-dimensional vector graphic to a new view of the object. In some embodiments, the server device(s) 106 includes, but is not limited to, a computing device (such as explained below with reference to FIG. 16).

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

A diffusion neural network (or diffusional model) refers to a likelihood-based model for image synthesis. In particular, a diffusion model is based on a Gaussian denoising process (e.g., based on a premise that the noises added to the original images are drawn from Gaussian distributions). The denoising process involves predicting the added noises using a neural network (e.g., a convolutional neural network such as UNet). During training, Gaussian noise is iteratively added to a digital image in a sequence of steps (or iterations) to generate a noise map (or noise representation). The neural network is trained to recreate the digital image by reversing the noising process. In particular, the diffusion neural network utilizes a plurality of steps (or iterations) to iteratively denoise the noise representation. The diffusion neural network can thus generate digital images from noise representations.

In some instances, the graphics rotation system 102 receives a request (e.g., from the client device 108) to rotate a view of an object depicted in a two-dimensional graphic. For example, the graphics rotation system 102 obtains the two-dimensional graphic and receives a request to generate a new two-dimensional graphic depicting the object rotated about one or more axes. Some embodiments of server device(s) 106 perform a variety of functions via the digital media management system 104 on the server device(s) 106. To illustrate, the server device(s) 106 (through the graphics rotation system 102 on the digital media management system 104) performs functions such as, but not limited to, receiving a user input to rotate an object depicted in a two-dimensional vector graphic from a first orientation through a three-dimensional space into a second orientation, concatenating a rasterized image of the two-dimensional vector graphic with a noised image in a height dimension to generate a vertically concatenated input image, and generating a new image from the vertically concatenated input image, the new image comprising a denoised image depicting the object in the second orientation according to the user input. In some embodiments, the server device(s) 106 utilizes the diffusion neural network 114 to generate the new image comprising the denoised image depicting the object in the second orientation. In some embodiments, the server device(s) 106 trains the diffusion neural network 114.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 16. Some embodiments of client device 108 perform a variety of functions via a client application 110 on client device 108. For example, the client device 108 (through the client application 110) performs functions such as, but not limited to, receiving a user input to rotate an object depicted in a two-dimensional vector graphic from a first orientation through a three-dimensional space into a second orientation, concatenating a rasterized image of the two-dimensional vector graphic with a noised image in a height dimension to generate a vertically concatenated input image, and generating a new image from the vertically concatenated input image, the new image comprising a denoised image depicting the object in the second orientation according to the user input. In some embodiments, the client device 108 utilizes the diffusion neural network 114 to generate the new image comprising the denoised image depicting the object in the second orientation. In some embodiments, the client device 108 trains the diffusion neural network 114.

To access the functionalities of the graphics rotation system 102 (as described above and in greater detail below), in one or more embodiments, a user interacts with the client application 110 on the client device 108. For example, the client application 110 includes one or more software applications (e.g., to generate new two-dimensional graphics depicting rotated objects in accordance with one or more embodiments described herein) installed on the client device 108, such as a digital media management application, an image editing application, and/or a graphic design application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the graphics rotation system 102 is hosted by the client application 110 on the client device 108 (e.g., additionally, or alternatively to being hosted by the digital media management system 104 on the server device(s) 106). For example, the graphics rotation system 102 performs the graphics rotation techniques described herein on the client device 108. In some implementations, the graphics rotation system 102 utilizes the server device(s) 106 to train and implement machine learning models (such as the diffusion neural network 114). In one or more embodiments, the graphics rotation system 102 utilizes the server device(s) 106 to train machine learning models (such as the diffusion neural network 114) and utilizes the client device 108 to implement or apply the machine learning models.

Further, although FIG. 1 illustrates the graphics rotation system 102 being implemented by a particular component and/or device within the system 100 (e.g., the server device(s) 106 and/or the client device 108), in some embodiments the graphics rotation system 102 is implemented, in whole or in part, by other computing devices and/or components in the system 100. For instance, in some embodiments, the graphics rotation system 102 is implemented on another client device. More specifically, in one or more embodiments, the description of (and acts performed by) the graphics rotation system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a request to rotate a two-dimensional vector graphic). In response, the graphics rotation system 102 on the server device(s) 106 performs operations described herein to generate a new two-dimensional graphic depicting the two-dimensional vector graphic rotated according to the request. The server device(s) 106 provides the output or results of the operations (e.g., a new two-dimensional graphic depicting a three-dimensionally rotated two-dimensional object of the two-dimensional vector graphic) to the client device 108. As another example, in some implementations, the graphics rotation system 102 on the client device 108 performs operations described herein to generate a new two-dimensional graphic depicting the two-dimensional vector graphic rotated according to the request. The client device 108 provides the output or results of the operations (e.g., a new two-dimensional graphic depicting a three-dimensionally rotated two-dimensional object of the two-dimensional vector graphic) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 16. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

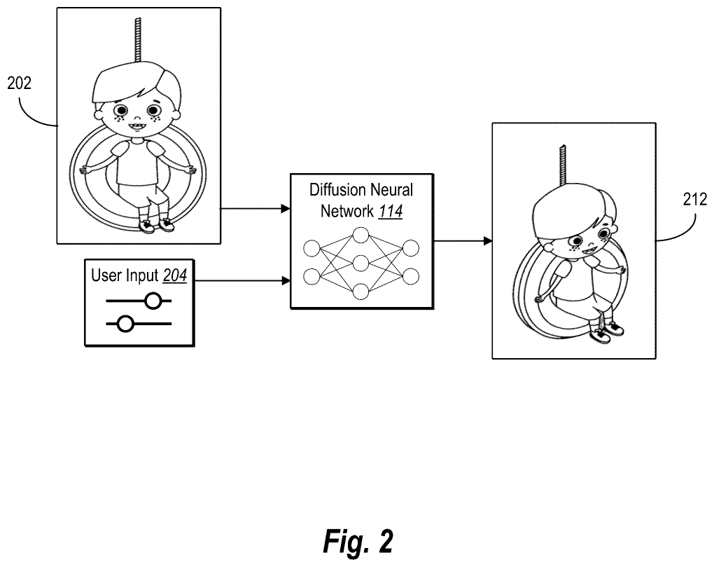

As discussed above, in some embodiments, the graphics rotation system 102 generates two-dimensional graphics depicting objects that have been rotated through a three-dimensional space. For instance, FIG. 2 illustrates the graphics rotation system 102 generating a new two-dimensional graphic based on a user input to rotate an object in accordance with one or more embodiments.

Specifically, FIG. 2 shows the graphics rotation system 102 accessing a two-dimensional vector graphic 202 and a user input 204 to rotate the two-dimensional vector graphic 202. Additionally, FIG. 2 shows the graphics rotation system 102 utilizing the diffusion neural network 114 to generate a new two-dimensional graphic 212 based on the two-dimensional vector graphic 202 and the user input 204.

To further illustrate, the graphics rotation system 102 receives the user input 204 requesting a new view of the two-dimensional vector graphic 202 in a new orientation. For example, the user input 204 includes a first input to rotate the two-dimensional vector graphic 202 about a first axis (for example, a vertical axis that lies in plane of the two-dimensional vector graphic 202) and a second input to rotate the two-dimensional vector graphic 202 about a second axis (for example, a horizontal axis that lies in plane of the two-dimensional vector graphic 202).

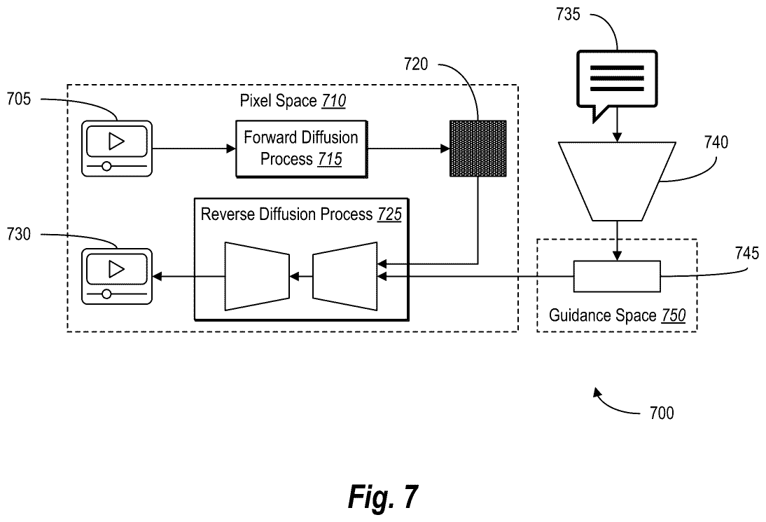

In some embodiments, the graphics rotation system 102 generates the new two-dimensional graphic 212 by utilizing the diffusion neural network 114 to denoise a noised image conditioned on a rasterized image of the two-dimensional vector graphic 202 and the user input 204. For example, the graphics rotation system 102 processes the rasterized image of the two-dimensional vector graphic 202 concatenated vertically with the noised image through the diffusion neural network 114 along with the user input 204 to condition the generation of the new two-dimensional graphic 212. Additional detail of how the graphics rotation system 102 utilizes the diffusion neural network 114 to generate the new two-dimensional graphic 212 is given below in connection with FIGS. 7-10.

Additionally, as further described below, in some implementations, the graphics rotation system 102 trains the diffusion neural network 114 to generate the new two-dimensional graphic 212 according to the user input 204. For example, the graphics rotation system 102 finetunes the diffusion neural network 114 to generate new views of objects depicted in two-dimensional vector graphics using albedo-only views of three-dimensional shapes. Thus, in some implementations, the graphics rotation system 102 trains the diffusion neural network to generate two-dimensional graphics that are vectorized for further use with vector graphic design.

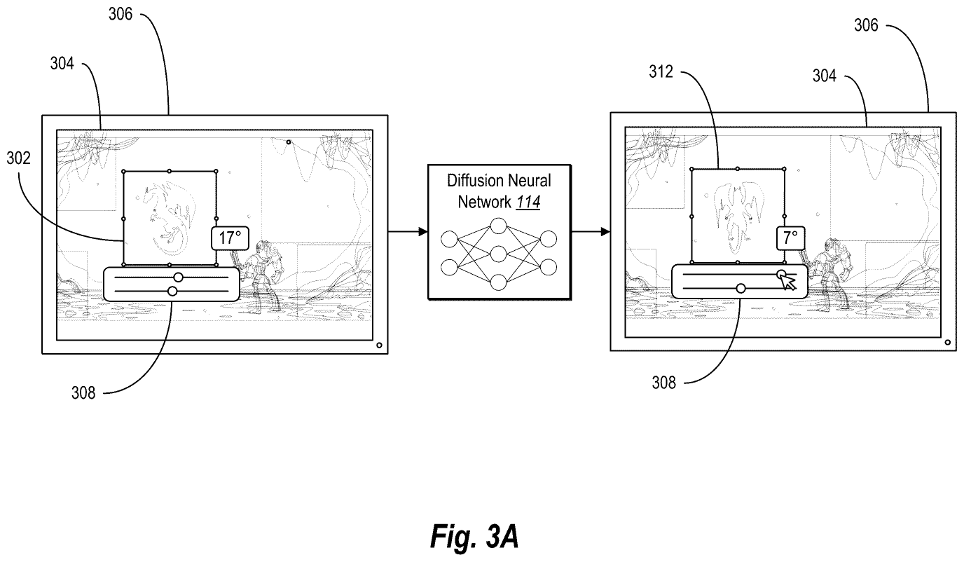

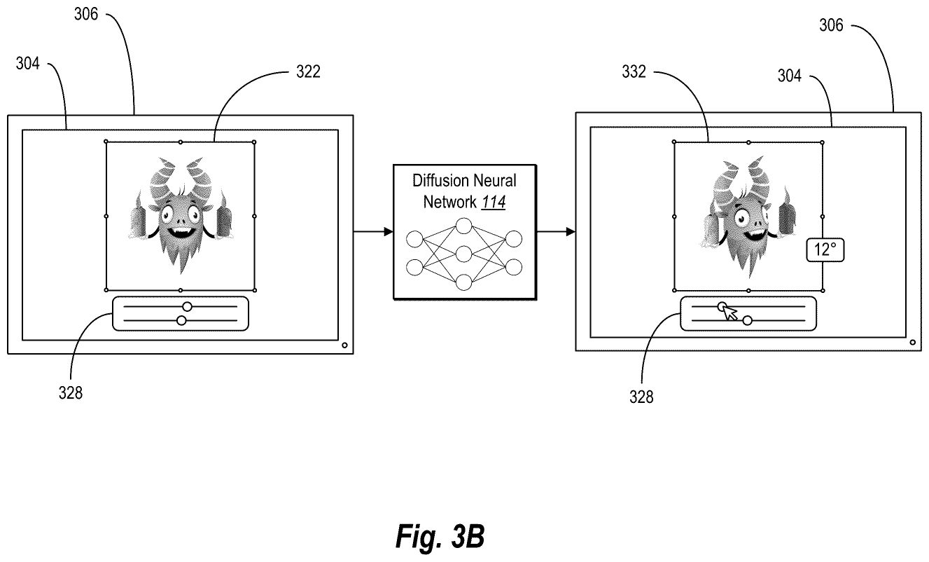

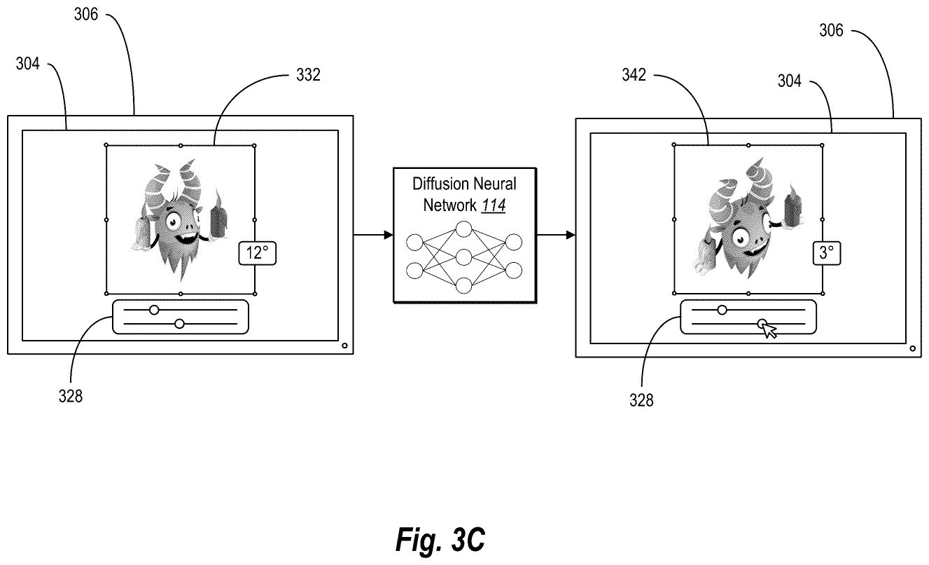

As discussed, in some embodiments, the graphics rotation system 102 provides a graphical user interface implementation for three-dimensional rotation of vector graphics. For instance, FIGS. 3A-3C illustrate the graphics rotation system 102 providing vector graphics for display via a graphical user interface of a client device in accordance with one or more embodiments. Additionally, FIGS. 3A-3C illustrate the graphics rotation system 102 generating, utilizing a diffusion neural network, new graphics for display via the graphical user interface in accordance with one or more embodiments.

Specifically, FIG. 3A shows the graphics rotation system 102 providing a two-dimensional vector graphic 302 in a first orientation for display via a graphical user interface 304 of a client device 306. More particularly, the two-dimensional vector graphic 302 depicts an object in the first orientation. Additionally, in some implementations, the graphics rotation system 102 provides a two-dimensional vector graphic scene for display via the graphical user interface 304. For example, the two-dimensional vector graphic scene includes the two-dimensional vector graphic 302 and one or more additional two-dimensional vector graphics.

A two-dimensional graphic includes a raster image or a vector graphic defining a view depicting one or more objects. For example, a two-dimensional graphic includes a vector graphic of an object in a particular orientation. As another example, a two-dimensional graphic includes a raster graphic of an object in a particular orientation. Similarly, a two-dimensional vector graphic includes a vector graphic defining parameters of geometric shapes for depicting one or more objects in a two-dimensional view. In some cases, a two-dimensional vector graphic is rasterized into a digital image for concatenation with another image and/or for processing through a machine learning model, such as a diffusion neural network. Alternatively, in some cases, a two-dimensional vector graphic includes a graphic generated as a raster graphic and subsequently vectorized into a vector graphic. An object includes a person, an animate object, or an inanimate object.

As additionally shown in FIG. 3A, in some implementations, the graphics rotation system 102 provides a selection element 308 whereby a user of the client device selects a new orientation for the object depicted in the two-dimensional vector graphic 302. For example, the graphics rotation system 102 receives, via the selection element 308, a user input to rotate the two-dimensional vector graphic 302 in a three-dimensional space to a second orientation. To illustrate, the user input includes a request to rotate the object depicted in the two-dimensional vector graphic 302 about an axis that lies in a plane of the graphical user interface 304, as if moving a portion of the object out of the plane of the graphical user interface 304. Thus, in some embodiments, the graphics rotation system 102 generates a new view of the object (e.g., from a different perspective) beyond merely the trivial case of rotation about an axis perpendicular to the plane of the graphical user interface 304, which would merely preserve the view of the object with its original dimensions and proportions. In other words, the graphics rotation system 102 generates new (e.g., from previously unseen perspectives) views of the object as if the object has been rotated through three-dimensional space.

As mentioned, in some implementations, the graphics rotation system 102 generates a new two-dimensional graphic 312 depicting the two-dimensional vector graphic 302 rotated according to the user input. For example, the graphics rotation system 102 utilizes the diffusion neural network 114 to generate the new two-dimensional graphic 312 depicting the object in the second orientation. To illustrate, the graphics rotation system 102 generates the new two-dimensional graphic 312 by utilizing the diffusion neural network 114 to denoise a noised image conditioned on a rasterized image of the two-dimensional vector graphic 302 and the user input.

Moreover, as shown in FIG. 3A, in some implementations, the graphics rotation system 102 provides the new two-dimensional graphic 312 in the second orientation for display via the graphical user interface 304 of the client device 306. Furthermore, in some embodiments, the graphics rotation system 102 generates a new two-dimensional vector graphic by vectorizing the new two-dimensional graphic 312. Additionally, in some implementations, the graphics rotation system 102 provides a two-dimensional vector graphic scene for display via the graphical user interface 304. For example, the graphics rotation system 102 generates a two-dimensional vector graphic scene including the new two-dimensional vector graphic (based on the new two-dimensional graphic 312) and one or more additional two-dimensional vector graphics.

In addition, FIG. 3B shows the graphics rotation system 102 providing a two-dimensional vector graphic 322 in a first orientation for display via the graphical user interface 304 of the client device 306. Moreover, the graphics rotation system 102 receives a first user input via a selection element 328 to rotate an object depicted in the two-dimensional vector graphic 322. For example, the first user input requests a rotation of the object through three-dimensional space about a first axis that lies in a plane of the graphical user interface 304.

As also shown, the graphics rotation system 102 generates a new two-dimensional graphic 332 utilizing the diffusion neural network 114. For example, the graphics rotation system 102 processes a rasterized image of the two-dimensional vector graphic 322 and the user input through the diffusion neural network 114 to generate the new two-dimensional graphic 332. In the example shown in FIG. 3B, the object depicted in the new two-dimensional graphic 332 is rotated (i.e., relative to the first orientation of the object depicted in the two-dimensional vector graphic 322) about a vertical axis into a second orientation.

Furthermore, as shown, the graphics rotation system 102 provides the new two-dimensional graphic 332 in the second orientation for display via the graphical user interface 304 of the client device 306. In some embodiments, a user provides successive user inputs to change the orientation of the object (e.g., about the first axis). For instance, in some cases, the selection element 328 includes a first slider bar by which the user slides an element to various angular positions of the object. As the user slides the element to different angular positions, the graphics rotation system 102 generates new views (i.e., new two-dimensional graphics) of the object according to the user selections.

Moreover, FIG. 3C shows the graphics rotation system 102 providing, for display via the graphical user interface 304 of the client device 306, the two-dimensional graphic 332 in the second orientation. Furthermore, the graphics rotation system 102 receives a second user input via the selection element 328 to rotate the object about a second axis. For example, the second user input requests a rotation of the object through three-dimensional space about the second axis, which lies in the plane of the graphical user interface 304 transverse to (e.g., orthogonal to, or with some angular offset from) the first axis.

As also shown, the graphics rotation system 102 generates a new two-dimensional graphic 342 utilizing the diffusion neural network 114. For example, the graphics rotation system 102 processes the new two-dimensional graphic 332 (or a rasterized image of the original two-dimensional vector graphic 322) and the second user input (or the first and second user inputs together) through the diffusion neural network 114 to generate the new two-dimensional graphic 342. In the example shown in FIG. 3C, the object depicted in the new two-dimensional graphic 342 is rotated (i.e., relative to the second orientation of the object depicted in the new two-dimensional graphic 332) about a horizontal axis into a third orientation.

Furthermore, as shown, the graphics rotation system 102 provides the new two-dimensional graphic 342 in the third orientation for display via the graphical user interface 304 of the client device 306. In some embodiments, a user provides successive user inputs to change the orientation of the object (e.g., about the second axis). For instance, in some cases, the selection element 328 includes a second slider bar (e.g., in addition to the first slider bar) by which the user slides an element to various angular positions of the object. As the user slides the element to different angular positions, the graphics rotation system 102 generates new views (i.e., new two-dimensional graphics) of the object according to the user selections.

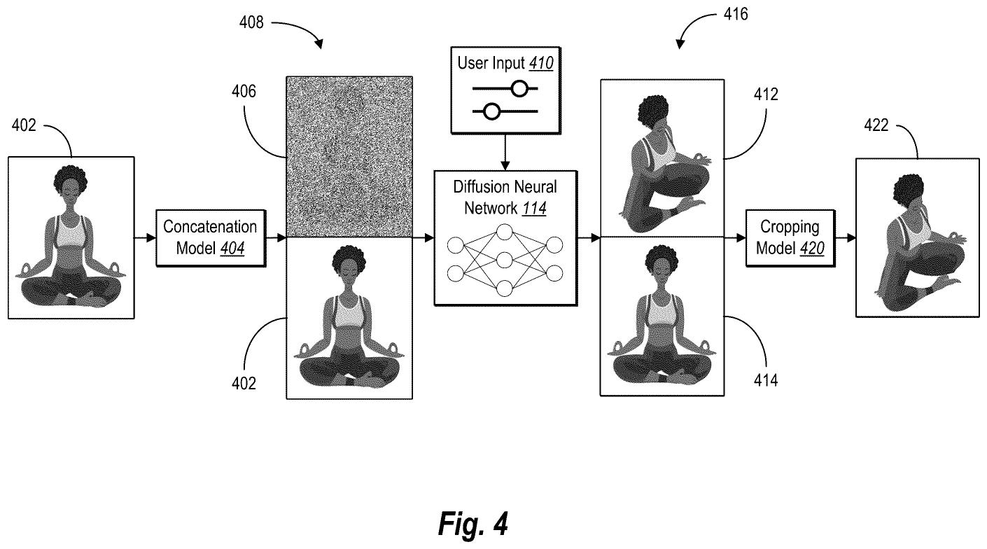

As discussed above, in some embodiments, the graphics rotation system 102 vertically concatenates a rasterized image of a two-dimensional vector graphic with a noised image to process through a media generation model. For instance, FIG. 4 illustrates the graphics rotation system 102 concatenating a rasterized image of a two-dimensional vector graphic with a noised image in a height dimension and processing the concatenated image through a diffusion neural network in accordance with one or more embodiments.

Specifically, FIG. 4 shows the graphics rotation system 102 accessing a two-dimensional vector graphic 402 and processing the two-dimensional vector graphic 402 through a concatenation model 404. To illustrate, the graphics rotation system 102 concatenates a rasterized image of the two-dimensional vector graphic 402 with a noised image 406 to generate a vertically concatenated input image 408. More particularly, the graphics rotation system 102 concatenates the rasterized image of the two-dimensional vector graphic 402 with the noised image 406 in a height dimension. In some embodiments, the graphics rotation system 102 positions the noised image 406 above the rasterized image of the two-dimensional vector graphic 402 in the vertically concatenated input image 408. Conversely, in some embodiments, the graphics rotation system 102 positions the noised image 406 below the rasterized image of the two-dimensional vector graphic 402 in the vertically concatenated input image 408.

To further illustrate, in some embodiments, the noised image 406 has the same dimensions (e.g., height, width, and number of color channels) as the rasterized image of the two-dimensional vector graphic 402. For instance, the graphics rotation system 102 concatenates the rasterized image of the two-dimensional vector graphic 402 with the noised image 406 by generating the vertically concatenated input image 408 with a height dimension of double a height of the rasterized image of the two-dimensional vector graphic, a width dimension equal to a width of the rasterized image of the two-dimensional vector graphic, and a channel dimension equal to a number of channels of the rasterized image of the two-dimensional vector graphic.

As mentioned, in some implementations, the graphics rotation system 102 generates the vertically concatenated input image 408 in response to receiving a user input to rotate the two-dimensional vector graphic 402. For example, the graphics rotation system 102 receives a user input 410 to rotate an object depicted in the two-dimensional vector graphic 402 from a first orientation through a three-dimensional space into a second orientation.

Moreover, as shown in FIG. 4, the graphics rotation system 102 generates a new image 416 from the vertically concatenated input image 408. For example, the graphics rotation system 102 utilizes the diffusion neural network 114 to denoise the vertically concatenated input image 408 conditioned on the user input 410. For instance, the graphics rotation system 102 utilizes the diffusion neural network 114 to generate the new image 416, which includes a denoised image 412 depicting the object in the second orientation. Additionally, in some cases, the new image 416 includes a surplus image 414 (e.g., the rasterized image of the two-dimensional vector graphic 402, either in its original form or in a different form). In some embodiments, the graphics rotation system 102 utilizes the diffusion neural network 114 to generate the new image 416 according to the techniques described below in connection with FIGS. 7-10.

Additionally, in some implementations, the graphics rotation system 102 crops the denoised image 412 from the new image 416. For instance, the graphics rotation system 102 removes the surplus image 414 from the new image 416 utilizing a cropping model 420 to generate an output two-dimensional graphic 422. Thus, as shown in FIG. 4, the graphics rotation system 102 generates a two-dimensional graphic depicting the object in the second orientation according to the user input 410.

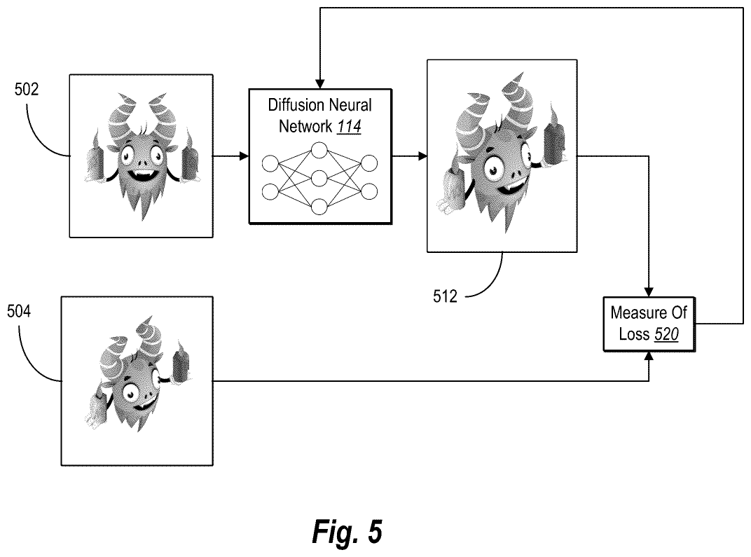

As noted above, in some embodiments, the graphics rotation system 102 trains or finetunes a media generation model. For instance, FIG. 5 illustrates the graphics rotation system 102 training a diffusion neural network using albedo-only images in accordance with one or more embodiments.

Specifically, FIG. 5 shows the graphics rotation system 102 accessing a first albedo-only view 502 of a three-dimensional shape in a first orientation and a second albedo-only view 504 of the three-dimensional shape in a second orientation. In some embodiments, the graphics rotation system 102 uses the first and second albedo-only views to train the diffusion neural network 114. An albedo-only view includes a graphic of an object that depicts base colors without shading.

For example, in some embodiments, the graphics rotation system 102 generates the first albedo-only view 502 and the second albedo-only view 504. For instance, the graphics rotation system 102 renders the first albedo-only view 502 with base colors of the three-dimensional shape in the first orientation. Similarly, in some embodiments, the graphics rotation system 102 renders the second albedo-only view 504 with base colors of the three-dimensional shape in the second orientation.

In addition, as shown in FIG. 5, the graphics rotation system 102 generates a two-dimensional graphic 512 depicting the three-dimensional shape rotated into the second orientation from the first albedo-only view. For instance, the graphics rotation system 102 utilizes the diffusion neural network 114 to denoise a noised image conditioned on the first albedo-only view of the three-dimensional shape in the first orientation, as described above and in additional detail below. Additionally, in some embodiments, the graphics rotation system 102 conditions the diffusion process with a training input (e.g., to rotate the object depicted in the first albedo-only view 502 from the first orientation to the second orientation).

Moreover, in some implementations, the graphics rotation system 102 determines a measure of loss 520 by comparing the two-dimensional graphic 512 and the second albedo-only view 504. Furthermore, in some implementations, the graphics rotation system 102 adjusts parameters of the diffusion neural network 114 to reduce the measure of loss 520 (e.g., in a subsequent training iteration). Moreover, in some embodiments, the graphics rotation system 102 utilizes the diffusion neural network 114 as a pretrained diffusion neural network and finetunes the diffusion neural network 114 using these techniques.

In some implementations, the graphics rotation system 102 provides improvements over existing systems by using albedo-only views in the training process. For example, by using albedo-only views, the graphics rotation system 102 trains the diffusion neural network 114 to focus on shapes and colors of objects in generated images, rather than shading or depth. Thus, the graphics rotation system 102 trains the diffusion neural network 114 to generate new images that are better suited for vector graphics (e.g., more readily vectorizable).

As described above in connection with FIG. 4, in some embodiments, the graphics rotation system 102 generates the two-dimensional graphic 512 depicting the three-dimensional shape rotated into the second orientation by generating a vertically concatenated input image for the diffusion neural network 114 by concatenating the first albedo-only view 502 with a noised image in a height dimension. For instance, the graphics rotation system 102 positions the noised image above the first albedo-only view 502 in the vertically concatenated input image.

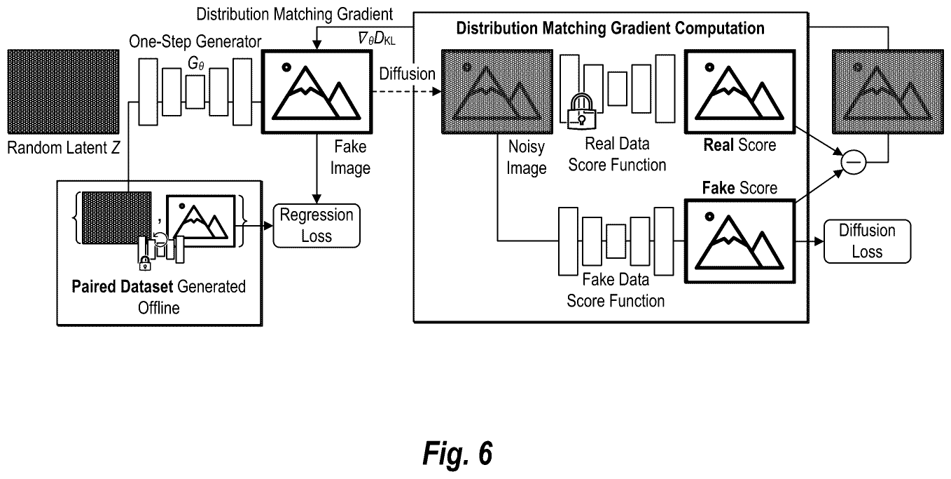

As mentioned, in some embodiments, the graphics rotation system 102 utilizes distribution matching distillation to train a media generation model. For instance, FIG. 6 illustrates the graphics rotation system 102 using a distribution matching distillation process to train a diffusion neural network in accordance with one or more embodiments.

To illustrate, FIG. 6 shows the graphics rotation system 102 adjusting parameters of the diffusion neural network using distribution matching distillation. In some embodiments, the graphics rotation system 102 trains a one-step generator Ge to map random noise z into a realistic image. Additionally, the graphics rotation system 102 pre-computes a collection of noise-image pairs and loads the noise from the collection and enforces a regression loss between the one-step generator Ge and the diffusion output. Moreover, the graphics rotation system 102 provides a distribution matching gradient VeDKL to the fake image to enhance realism. Additionally, the graphics rotation system 102 injects a random amount of noise to the fake image and processes the noisy image through two diffusion models. One of the diffusion models is pretrained on the real data and the other diffusion model is continually trained on the fake images with a diffusion loss. Denoising scores indicate directions to make the images more realistic or fake. The graphics rotation system 102 determines a difference between the real score and the fake score, which represents the direction toward more realism and less fakeness. The graphics rotation system 102 backpropagates a gradient computed from the difference to the one-step generator.

In some implementations, by using distribution matching distillation to train the diffusion neural network 114, the graphics rotation system 102 enhances computing efficiency over existing image synthesis systems. For example, by using distribution matching distillation, the graphics rotation system 102 generates high-quality two-dimensional graphics without an iterative sampling procedure that requires numerous iterations of computations.

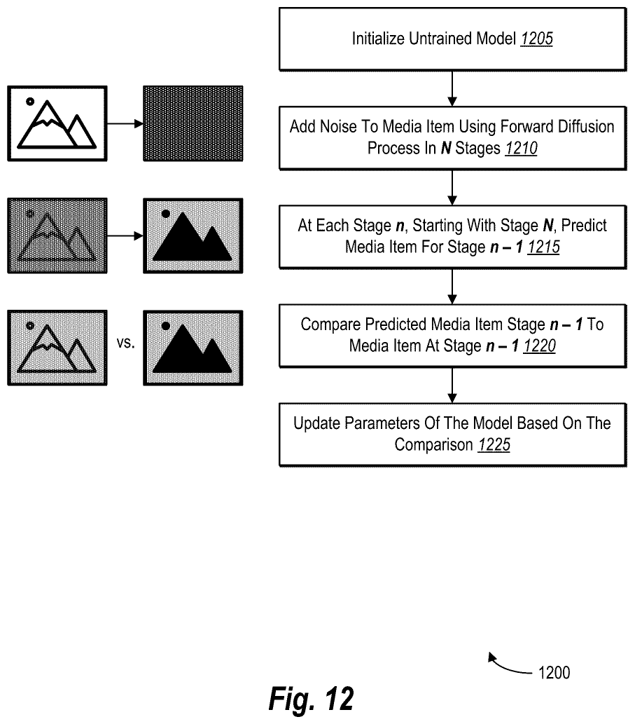

As mentioned, in some embodiments, the graphics rotation system 102 uses the distribution matching distillation process to fine-tune the diffusion neural network 114. For example, the graphics rotation system 102 first trains the diffusion neural network 114 (or obtains a pretrained diffusion neural network) using the diffusion training techniques described below in connection with FIG. 12 and using albedo-only training images as described above in connection with FIG. 5. Then, the graphics rotation system 102 fine-tunes the diffusion neural network 114 using distribution matching distillation.

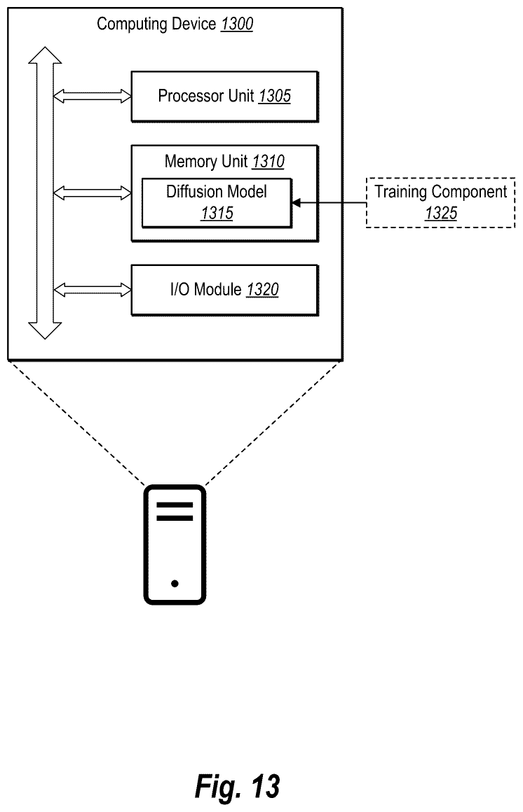

FIG. 7 shows an example of a guided diffusion model 700 according to aspects of the present disclosure. In some examples, guided diffusion model 700 describes the operation and architecture of the diffusion model 1315 described with reference to FIG. 13. The guided latent diffusion model 700 depicted in FIG. 7 is an example of, or includes aspects of, a media generation model (e.g., the diffusion neural network 114) as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 740 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Model (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

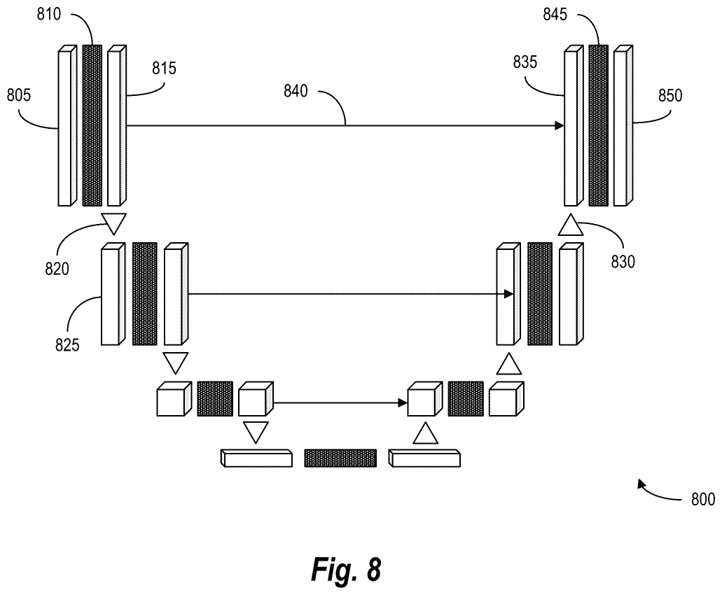

FIG. 8 shows an example of a U-Net 800 according to aspects of the present disclosure. In some examples, U-Net 800 is an example of the component that performs the reverse diffusion process 725 of guided diffusion model 700 described with reference to FIG. 7 and includes architectural elements of the diffusion model 1315 described with reference to FIG. 13. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

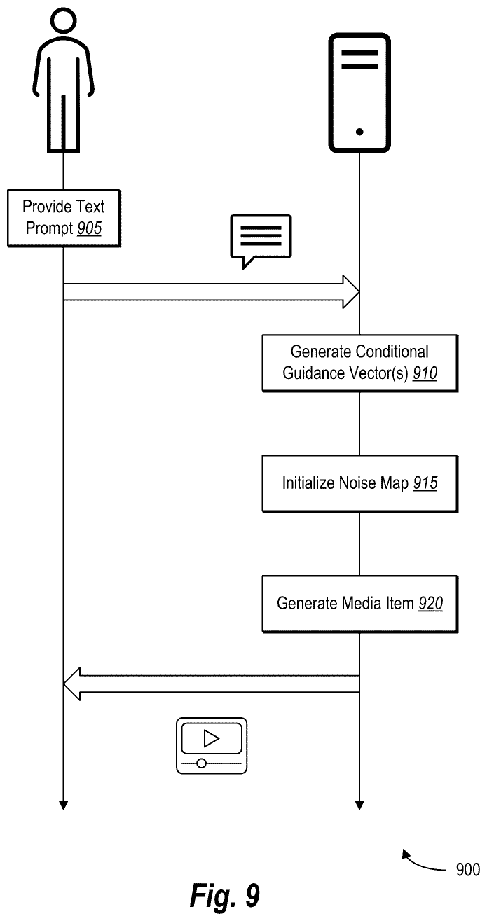

FIG. 9 shows an example of a method 900 for conditional media generation according to aspects of the present disclosure. In some examples, method 900 describes an operation of the diffusion model 1315 described with reference to FIG. 13 such as an application of the guided diffusion model 700 described with reference to FIG. 7. In some examples, these operations are performed by a system including a processor executing a set of codes to control functional elements of an apparatus such as the media generation model described in FIG. 7.

Additionally, or alternatively, steps of the method 900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 905, a user provides a text prompt describing content to be included in a generated media item. For example, a user may provide the prompt “a person playing with a cat.” In some examples, guidance can be provided in a form other than text, such as via an image, a sketch, or a layout.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 915, a noise map is initialized that includes random noise. The noise map may be in a pixel space or a latent space. By initializing a media item with random noise, different variations of a media item including the content described by the conditional guidance can be generated.

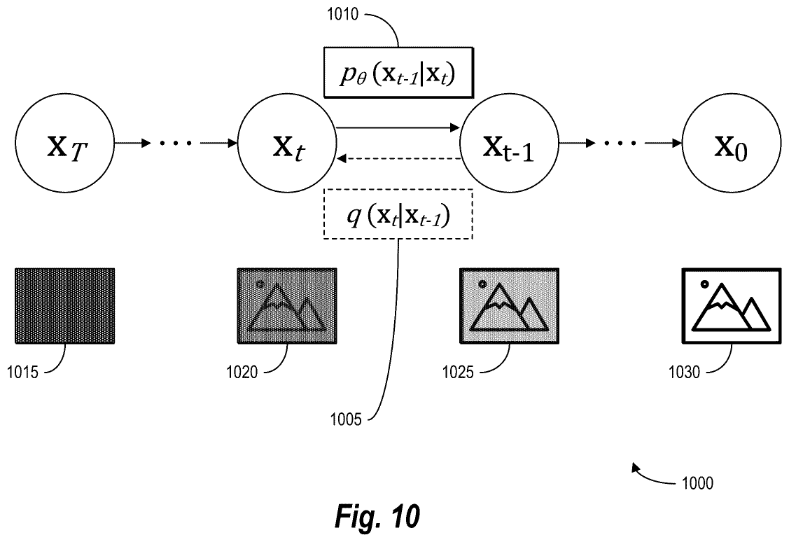

At operation 920, the system generates a media item based on the noise map and the conditional guidance vector. For example, the media item may be generated using a reverse diffusion process as described with reference to FIG. 10.

FIG. 10 shows a diffusion process 1000 according to aspects of the present disclosure. In some examples, diffusion process 1000 describes an operation of the diffusion model 1315 described with reference to FIG. 13, such as the reverse diffusion process 725 of guided diffusion model 700 described with reference to FIG. 7.

As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) and intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p(xₜ-1|xₜ). At each step t−1, the reverse diffusion process 1010 takes xₜ, such as first intermediate media item 1020, and t as input. Here, t represents a step in the sequence of transitions associated with different noise levels. The reverse diffusion process 1010 outputs xₜ₋₁, such as second intermediate media item 1025 iteratively until x_{T} reverts back to x₀, the original media item 1030. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) .$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) ,$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data % is mapped back into the pixel space from the latent space as output. In some examples, x₀ represents an original input media item with low quality, latent variables x₁, . . . , x_{T} represent noisy media items, and x represents the generated item with high quality.

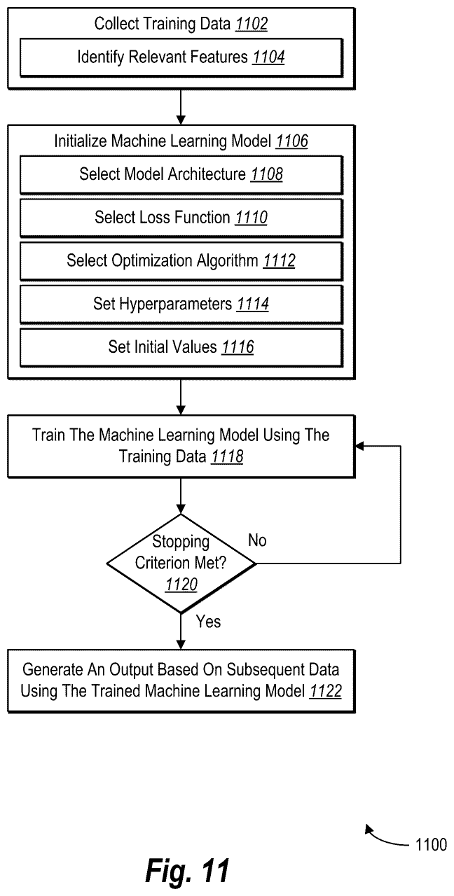

FIG. 11 is a flow diagram depicting an algorithm as a step-by-step procedure 1100 in an example implementation of operations performable for training a machine-learning model. In some embodiments, the procedure 1100 describes an operation of the training component 1325 described for configuring the diffusion model 1315 as described with reference to FIG. 13. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (block 1112) that is to be used in conjunction with the loss function to optimize parameters of the machine-learning model during training, examples of which include gradient descent, stochastic gradient descent (SGD), and so forth.

Initialization of the machine-learning model further includes setting hyperparameters (block 1114) and initial values (block 1116) of the machine-learning model, examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

FIG. 12 shows an example of a method 1200 for training a diffusion model according to aspects of the present disclosure. In some embodiments, the method 1200 describes an operation of the training component 1325 described for configuring the diffusion model 1315 as described with reference to FIG. 13. The method 1200 represents an example for training a reverse diffusion process as described above with reference to FIG. 10. In some examples, these operations are performed by a system including a processor executing a set of codes to control functional elements of an apparatus, such as the guided diffusion model described in FIG. 7.

Additionally, or alternatively, certain processes of method 1200 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each of the layer blocks, the location of skip connections, and the like.

At operation 1210, the system adds noise to a media item using a forward diffusion process in N stages. In some cases, the forward diffusion process is a fixed process where Gaussian noise is successively added to the media item. In latent diffusion models, the Gaussian noise may be successively added to features in a latent space.

At operation 1215, the system at each stage n, starting with stage N, uses a reverse diffusion process to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (e.g., media item or features) at stage n−1 to an actual media item (or features), such as the output at stage n−1 or the original input. For example, given observed data x, the diffusion model may be trained to minimize the variational upper bound of the negative log-likelihood−log p_{θ}(x) of the training data.

At operation 1225, the system updates parameters of the model based on the comparison. For example, parameters of a U-Net may be updated using gradient descent. Time-dependent parameters of the Gaussian transitions can also be learned.

FIG. 13 shows an example of a computing device 1300 according to aspects of the present disclosure. The computing device 1300 may include an example of, or aspects of, the guided diffusion model described with reference to FIG. 7 and the U-Net described with reference to FIG. 8. In some embodiments, computing device 1300 includes processor unit 1305, memory unit 1310, diffusion model 1315, I/O module 1320, and training component 1325. Training component 1325 updates parameters of the diffusion model 1315 stored in memory unit 1310. In some examples, the training component 1325 is located outside the computing device 1300.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing. According to some aspects, processor unit 1305 comprises one or more processors described with reference to FIG. 16.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state. According to some aspects, memory unit 1310 is an example of the memory 1604 described with reference to FIG. 16.

According to some aspects, computing device 1300 uses one or more processors of processor unit 1305 to execute instructions stored in memory unit 1310 to perform functions described herein. For example, the computing device 1300 may generate a new two-dimensional graphic depicting a two-dimensional graphic rotated according to a user input.

The memory unit 1310 may include a diffusion model 1315 (e.g., the diffusion neural network 114) trained to generate the new two-dimensional graphic depicting the two-dimensional graphic rotated according to the user input. For example, after training, the diffusion model 1315 may perform inferencing operations as described with reference to FIGS. 9 and 10 to generate the new two-dimensional graphic.

In some embodiments, the diffusion model 1315 is an artificial neural network (ANN) such as the guided diffusion model described with reference to FIG. 7 and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1325 may train the diffusion model 1315. For example, parameters of the diffusion model 1315 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 11 and 12). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion model 1315 can be used to make predictions on new, unseen data (i.e., during inference).

I/O module 1320 receives inputs from and transmits outputs of the computing device 1300 to other devices or users. For example, I/O module 1320 receives inputs for the diffusion model 1315 and transmits outputs of the diffusion model 1315. According to some aspects, I/O module 1320 is an example of the I/O interface 1608 described with reference to FIG. 16.

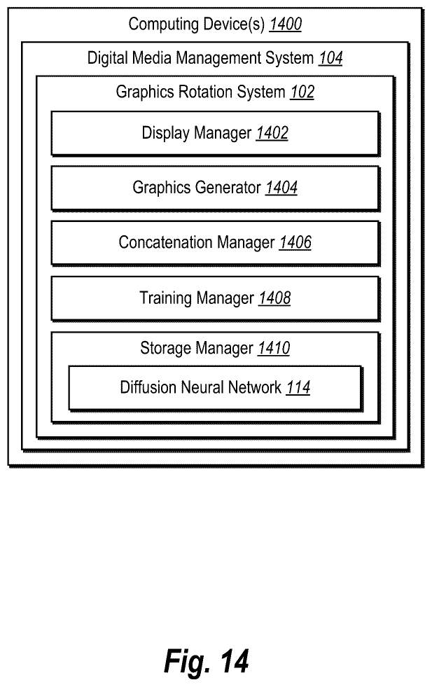

Turning now to FIG. 14, additional detail will be provided regarding components and capabilities of one or more embodiments of the graphics rotation system 102. In particular, FIG. 14 illustrates an example graphics rotation system 102 executed by a computing device(s) 1400 (e.g., the server device(s) 106 or the client device 108). As shown by the embodiment of FIG. 14, the computing device(s) 1400 includes or hosts the digital media management system 104 and/or the graphics rotation system 102. Furthermore, as shown in FIG. 14, the graphics rotation system 102 includes a display manager 1402, a graphics generator 1404, a concatenation manager 1406, a training manager 1408, and a storage manager 1410.

As shown in FIG. 14, the graphics rotation system 102 includes a display manager 1402. In some implementations, the display manager 1402 provides one or more graphics for display via a graphical user interface of a client device. For example, the display manager 1402 provides a two-dimensional vector graphic in a first orientation and/or a new two-dimensional graphic in a second orientation for display via a graphical user interface.

In addition, as shown in FIG. 14, the graphics rotation system 102 includes a graphics generator 1404. In some implementations, the graphics generator 1404 generates a new two-dimensional graphic depicting a two-dimensional vector graphic rotated through a three-dimensional space from a first orientation to a second orientation. Additionally, in some implementations, the graphics generator 1404 vectorizes the new two-dimensional graphic to generate a new two-dimensional vector graphic. Moreover, in some implementations, the graphics generator 1404 utilizes the diffusion neural network 114 to generate the new two-dimensional graphic.

Moreover, as shown in FIG. 14, the graphics rotation system 102 includes a concatenation manager 1406. In some implementations, the concatenation manager 1406 concatenates a rasterized image of the two-dimensional vector graphic with a noised image to generate a vertically concatenated input image for a media generation model, such as the diffusion neural network 114. For example, the concatenation manager 1406 positions the noised image above the rasterized image of the two-dimensional vector graphic in a height dimension of the two-dimensional vector graphic.

Furthermore, as shown in FIG. 14, the graphics rotation system 102 includes a training manager 1408. In some implementations, the training manager 1408 trains (e.g., modifies parameters of) one or more machine learning models, as described above, including the diffusion neural network 114. For example, the training manager 1408 adjusts parameters of the diffusion neural network 114 to reduce a measure of loss determined by comparing a generated two-dimensional graphic with a training graphic, such as an albedo-only view of a three-dimensional shape in a target orientation.

Additionally, as shown in FIG. 14, the graphics rotation system 102 includes a storage manager 1410. In some implementations, the storage manager 1410 stores information (e.g., via one or more memory devices) on behalf of the graphics rotation system 102. For example, the storage manager 1410 stores parameters of the diffusion neural network 114. Additionally, the storage manager 1410 stores digital images, such as source two-dimensional vector graphics, generated two-dimensional graphics, and vectorized two-dimensional vector graphics.

Each of the components 1402-1410 of the graphics rotation system 102 includes software, hardware, or both. For example, the components 1402-1410 include one or more instructions stored on a computer-readable storage medium and executable by processors of one or more computing devices, such as a client device or server device. When executed by the one or more processors, in some implementations, the computer-executable instructions of the graphics rotation system 102 cause the computing device(s) to perform the methods described herein. Alternatively, in one or more implementations, the components 1402-1410 include hardware, such as a special purpose processing device to perform a certain function or group of functions. Alternatively, in some implementations, the components 1402-1410 of the graphics rotation system 102 include a combination of computer-executable instructions and hardware.

Furthermore, the components 1402-1410 of the graphics rotation system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 1402-1410 are implemented as a stand-alone application, such as a desktop or mobile application. Furthermore, in various implementations, the components 1402-1410 are implemented as one or more web-based applications hosted on a remote server. In some implementations, the components 1402-1410 are implemented in a suite of mobile device applications or “apps.” To illustrate, in some implementations, the components 1402-1410 are implemented in an application, including but not limited to Adobe Creative Cloud and Adobe Illustrator. The foregoing are either registered trademarks or trademarks of Adobe in the United States and/or other countries.

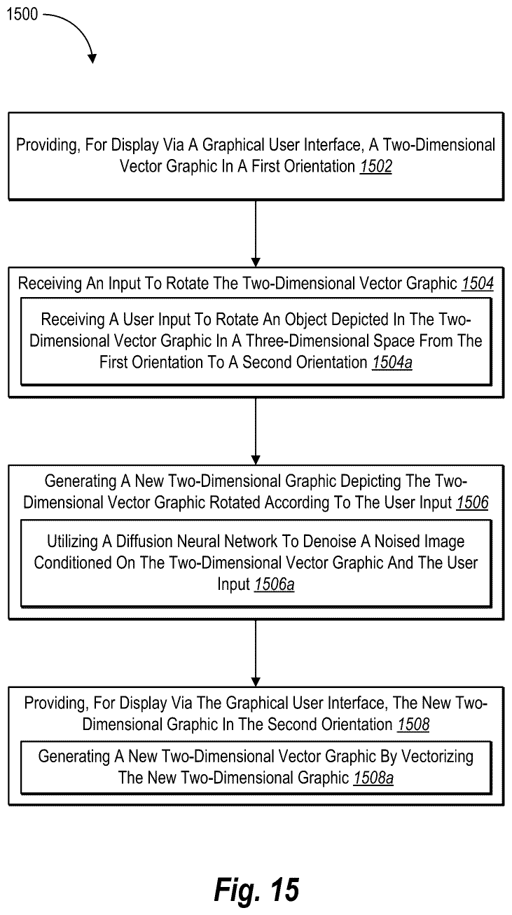

FIGS. 1-14, the corresponding text, and the examples provide a number of different methods, systems, devices, and non-transitory computer-readable media of the graphics rotation system 102. In addition to the foregoing, one or more embodiments are described in terms of flowcharts comprising acts for accomplishing a particular result, as shown in FIG. 15. In some implementations, the processes of the graphics rotation system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 15 illustrates a flowchart of a series of acts 1500 for generating rotated views of two-dimensional graphics in accordance with one or more implementations. While FIG. 15 illustrates acts according to one implementation, alternative implementations omit, add to, reorder, and/or modify any of the acts shown in FIG. 15. In one or more implementations, the acts of FIG. 15 are performed as part of a method (e.g., a computer-implemented method). Alternatively, in one or more implementations, a non-transitory computer-readable storage medium comprises instructions that, when executed by one or more processors, cause a computing device to perform the acts of FIG. 15. In some implementations, a system performs the acts of FIG. 15.

As shown in FIG. 15, the series of acts 1500 includes an act 1502 of providing, for display via a graphical user interface, a two-dimensional vector graphic in a first orientation, an act 1504 of receiving an input to rotate the two-dimensional vector graphic, an act 1506 of generating a new two-dimensional graphic depicting the two-dimensional vector graphic rotated according to the user input, and an act 1508 of providing, for display via the graphical user interface, the new two-dimensional graphic in the second orientation. In addition, as shown in FIG. 15, the series of acts 1500 includes an act 1504a of receiving a user input to rotate an object depicted in the two-dimensional vector graphic in a three-dimensional space from the first orientation to a second orientation, an act 1506a of utilizing a diffusion neural network to denoise a noised image conditioned on the two-dimensional vector graphic and the user input, and an act 1508a of generating a new two-dimensional vector graphic by vectorizing the new two-dimensional graphic.

In particular, in some implementations, the act 1502 includes providing, for display via a graphical user interface of a client device, a two-dimensional vector graphic in a first orientation, the act 1504 includes receiving a user input to rotate the two-dimensional vector graphic in a three-dimensional space to a second orientation, the act 1506 includes generating, utilizing a diffusion neural network, a new two-dimensional graphic depicting the two-dimensional vector graphic rotated according to the user input, and the act 1508 includes providing, for display via the graphical user interface, the new two-dimensional graphic in the second orientation.

For example, in some implementations, the series of acts 1500 includes receiving the user input to rotate the two-dimensional vector graphic by receiving a first user input to rotate an object depicted in the two-dimensional vector graphic about a first axis that lies in a plane of the graphical user interface. Moreover, in some implementations, the series of acts 1500 includes receiving the user input to rotate the two-dimensional vector graphic further by receiving a second user input to rotate the object depicted in the two-dimensional vector graphic about a second axis that lies in the plane of the graphical user interface transverse to the first axis. Furthermore, in some implementations, the series of acts 1500 includes generating the new two-dimensional graphic by utilizing the diffusion neural network to denoise a noised image conditioned on a rasterized image of the two-dimensional vector graphic and the user input.

Additionally, in some implementations, the series of acts 1500 includes generating the new two-dimensional graphic by generating a vertically concatenated input image for the diffusion neural network by concatenating a rasterized image of the two-dimensional vector graphic with a noised image in a height dimension. Moreover, in some implementations, the series of acts 1500 includes concatenating the rasterized image of the two-dimensional vector graphic with the noised image in the height dimension by positioning the noised image above the rasterized image of the two-dimensional vector graphic in the vertically concatenated input image. Furthermore, in some implementations, the series of acts 1500 includes generating the new two-dimensional graphic further by utilizing the diffusion neural network to denoise the vertically concatenated input image conditioned on the user input.

Additionally, in some implementations, the series of acts 1500 includes generating a new two-dimensional vector graphic by vectorizing the new two-dimensional graphic. Moreover, in some implementations, the series of acts 1500 includes generating a two-dimensional vector graphic scene including the new two-dimensional vector graphic and an additional two-dimensional vector graphic.

In addition, in some implementations, the series of acts 1500 includes receiving a user input to rotate an object depicted in a two-dimensional vector graphic from a first orientation through a three-dimensional space into a second orientation; concatenating, in a height dimension, a rasterized image of the two-dimensional vector graphic with a noised image to generate a vertically concatenated input image; generating, from the vertically concatenated input image utilizing a diffusion neural network, a new image comprising a denoised image depicting the object in the second orientation according to the user input; and cropping the denoised image depicting the object in the second orientation from the new image.

For example, in some implementations, the series of acts 1500 includes receiving the user input to rotate the object by receiving a first user input to rotate the object about a first axis and a second user input to rotate the object about a second axis transverse to the first axis. Moreover, in some implementations, the series of acts 1500 includes concatenating the rasterized image of the two-dimensional vector graphic with the noised image by positioning the noised image above the rasterized image of the two-dimensional vector graphic in the vertically concatenated input image.

Furthermore, in some implementations, the series of acts 1500 includes generating the new image by utilizing the diffusion neural network to denoise the vertically concatenated input image conditioned on the user input. Additionally, in some implementations, the series of acts 1500 includes cropping the denoised image from the new image by removing a surplus image from the new image. Moreover, in some implementations, the series of acts 1500 includes concatenating the rasterized image of the two-dimensional vector graphic with the noised image by generating the vertically concatenated input image with a height dimension of double a height of the rasterized image of the two-dimensional vector graphic, a width dimension equal to a width of the rasterized image of the two-dimensional vector graphic, and a channel dimension equal to a number of channels of the rasterized image of the two-dimensional vector graphic.

In addition, in some implementations, the series of acts 1500 includes accessing a first albedo-only view of a three-dimensional shape in a first orientation and a second albedo-only view of the three-dimensional shape in a second orientation; generating, utilizing a diffusion neural network, a two-dimensional graphic depicting the three-dimensional shape rotated into the second orientation from the first albedo-only view; and adjusting parameters of the diffusion neural network to reduce a measure of loss determined by comparing the two-dimensional graphic and the second albedo-only view.

For example, in some implementations, the series of acts 1500 includes accessing the first albedo-only view of the three-dimensional shape in the first orientation by rendering the first albedo-only view with base colors of the three-dimensional shape. Moreover, in some implementations, the series of acts 1500 includes generating the two-dimensional graphic depicting the three-dimensional shape rotated into the second orientation by utilizing the diffusion neural network to denoise a noised image conditioned on the first albedo-only view of the three-dimensional shape in the first orientation.

Furthermore, in some implementations, the series of acts 1500 includes generating the two-dimensional graphic depicting the three-dimensional shape rotated into the second orientation by generating a vertically concatenated input image for the diffusion neural network by concatenating the first albedo-only view with a noised image in a height dimension. Additionally, in some implementations, the series of acts 1500 includes concatenating the first albedo-only view with the noised image in the height dimension by positioning the noised image above the first albedo-only view in the vertically concatenated input image. Moreover, in some implementations, the series of acts 1500 includes further adjusting the parameters of the diffusion neural network using distribution matching distillation.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 16 illustrates a block diagram of an example computing device 1600 that may be configured to perform one or more of the processes described above. One will appreciate that one or more computing devices, such as the computing device 1600, may represent the computing devices described above (e.g., the computing device 1300, the computing device(s) 1400, the server device(s) 106, or the client device 108). In one or more embodiments, the computing device 1600 may be a mobile device (e.g., a mobile telephone, a smartphone, a PDA, a tablet, a laptop, a camera, a tracker, a watch, a wearable device, etc.). In some embodiments, the computing device 1600 may be a non-mobile device (e.g., a desktop computer or another type of client device). Further, the computing device 1600 may be a server device that includes cloud-based processing and storage capabilities.

As shown in FIG. 16, the computing device 1600 can include one or more processor(s) 1602, memory 1604, a storage device 1606, input/output interfaces 1608 (or “I/O interfaces 1608”), and a communication interface 1610, which may be communicatively coupled by way of a communication infrastructure (e.g., bus 1612). While the computing device 1600 is shown in FIG. 16, the components illustrated in FIG. 16 are not intended to be limiting. Additional or alternative components may be used in other embodiments. Furthermore, in certain embodiments, the computing device 1600 includes fewer components than those shown in FIG. 16. Components of the computing device 1600 shown in FIG. 16 will now be described in additional detail.

In particular embodiments, the processor(s) 1602 includes hardware for executing instructions, such as those making up a computer program. As an example, and not by way of limitation, to execute instructions, the processor(s) 1602 may retrieve (or fetch) the instructions from an internal register, an internal cache, memory 1604, or a storage device 1606 and decode and execute them.

The computing device 1600 includes the memory 1604, which is coupled to the processor(s) 1602. The memory 1604 may be used for storing data, metadata, and programs for execution by the processor(s). The memory 1604 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1604 may be internal or distributed memory.

The computing device 1600 includes the storage device 1606 for storing data or instructions. As an example, and not by way of limitation, the storage device 1606 can include a non-transitory storage medium described above. The storage device 1606 may include a hard disk drive (“HDD”), flash memory, a Universal Serial Bus (“USB”) drive or a combination these or other storage devices.

As shown, the computing device 1600 includes one or more I/O interfaces 1608, which are provided to allow a user to provide input to (such as user strokes), receive output from, and otherwise transfer data to and from the computing device 1600. These I/O interfaces 1608 may include a mouse, keypad or a keyboard, a touch screen, camera, optical scanner, network interface, modem, other known I/O devices or a combination of such I/O interfaces 1608. The touch screen may be activated with a stylus or a finger.

The I/O interfaces 1608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1608 are configured to provide graphical data to a display for presentation to a user. The graphical data may be representative of one or more graphical user interfaces and/or any other graphical content as may serve a particular implementation.

The computing device 1600 can further include a communication interface 1610. The communication interface 1610 can include hardware, software, or both. The communication interface 1610 provides one or more interfaces for communication (such as, for example, packet-based communication) between the computing device and one or more other computing devices or one or more networks. As an example, and not by way of limitation, communication interface 1610 may include a network interface controller (“NIC”) or network adapter for communicating with an Ethernet or other wire-based network or a wireless NIC (“WNIC”) or wireless adapter for communicating with a wireless network, such as a WI-FI. The computing device 1600 can further include the bus 1612. The bus 1612 can include hardware, software, or both that connects components of computing device 1600 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, for display via a graphical user interface of a client device, a two-dimensional vector graphic in a first orientation;
receiving a user input to rotate the two-dimensional vector graphic in a three-dimensional space to a second orientation;
generating, utilizing a diffusion neural network, a new two-dimensional graphic depicting the two-dimensional vector graphic rotated according to the user input; and
providing, for display via the graphical user interface, the new two-dimensional graphic in the second orientation.

2. The computer-implemented method of claim 1, wherein receiving the user input to rotate the two-dimensional vector graphic comprises receiving a first user input to rotate an object depicted in the two-dimensional vector graphic about a first axis that lies in a plane of the graphical user interface.

3. The computer-implemented method of claim 2, wherein receiving the user input to rotate the two-dimensional vector graphic further comprises receiving a second user input to rotate the object depicted in the two-dimensional vector graphic about a second axis that lies in the plane of the graphical user interface transverse to the first axis.

4. The computer-implemented method of claim 1, wherein generating the new two-dimensional graphic comprises utilizing the diffusion neural network to denoise a noised image conditioned on a rasterized image of the two-dimensional vector graphic and the user input.

5. The computer-implemented method of claim 1, wherein generating the new two-dimensional graphic comprises generating a vertically concatenated input image for the diffusion neural network by concatenating a rasterized image of the two-dimensional vector graphic with a noised image in a height dimension.

6. The computer-implemented method of claim 5, wherein concatenating the rasterized image of the two-dimensional vector graphic with the noised image in the height dimension comprises positioning the noised image above the rasterized image of the two-dimensional vector graphic in the vertically concatenated input image.

7. The computer-implemented method of claim 5, wherein generating the new two-dimensional graphic further comprises utilizing the diffusion neural network to denoise the vertically concatenated input image conditioned on the user input.

8. The computer-implemented method of claim 1, further comprising:
generating a new two-dimensional vector graphic by vectorizing the new two-dimensional graphic; and
generating a two-dimensional vector graphic scene including the new two-dimensional vector graphic and additional two-dimensional vector graphics.

9. A system comprising:
a memory component; and
one or more processing devices coupled to the memory component, the one or more processing devices to perform operations comprising:
receiving a user input to rotate an object depicted in a two-dimensional vector graphic from a first orientation through a three-dimensional space into a second orientation;
concatenating, in a height dimension, a rasterized image of the two-dimensional vector graphic with a noised image to generate a vertically concatenated input image;
generating, from the vertically concatenated input image utilizing a diffusion neural network, a new image comprising a denoised image depicting the object in the second orientation according to the user input; and
cropping the denoised image depicting the object in the second orientation from the new image.

10. The system of claim 9, wherein receiving the user input to rotate the object comprises receiving a first user input to rotate the object about a first axis and a second user input to rotate the object about a second axis transverse to the first axis.

11. The system of claim 9, wherein concatenating the rasterized image of the two-dimensional vector graphic with the noised image comprises positioning the noised image above the rasterized image of the two-dimensional vector graphic in the vertically concatenated input image.

12. The system of claim 9, wherein generating the new image comprises utilizing the diffusion neural network to denoise the vertically concatenated input image conditioned on the user input.

13. The system of claim 9, wherein cropping the denoised image from the new image comprises removing a surplus image from the new image.

14. The system of claim 9, wherein concatenating the rasterized image of the two-dimensional vector graphic with the noised image comprises generating the vertically concatenated input image with a height dimension of double a height of the rasterized image of the two-dimensional vector graphic, a width dimension equal to a width of the rasterized image of the two-dimensional vector graphic, and a channel dimension equal to a number of channels of the rasterized image of the two-dimensional vector graphic.

15. A non-transitory computer-readable medium storing executable instructions that, when executed by a processing device, cause the processing device to perform operations comprising:
accessing a first albedo-only view of a three-dimensional shape in a first orientation and a second albedo-only view of the three-dimensional shape in a second orientation;
generating, utilizing a diffusion neural network, a two-dimensional graphic depicting the three-dimensional shape rotated into the second orientation from the first albedo-only view; and
adjusting parameters of the diffusion neural network to reduce a measure of loss determined by comparing the two-dimensional graphic and the second albedo-only view.

16. The non-transitory computer-readable medium of claim 15, wherein accessing the first albedo-only view of the three-dimensional shape in the first orientation comprises rendering the first albedo-only view with base colors of the three-dimensional shape.

17. The non-transitory computer-readable medium of claim 15, wherein generating the two-dimensional graphic depicting the three-dimensional shape rotated into the second orientation comprises utilizing the diffusion neural network to denoise a noised image conditioned on the first albedo-only view of the three-dimensional shape in the first orientation.

18. The non-transitory computer-readable medium of claim 15, wherein generating the two-dimensional graphic depicting the three-dimensional shape rotated into the second orientation comprises generating a vertically concatenated input image for the diffusion neural network by concatenating the first albedo-only view with a noised image in a height dimension.

19. The non-transitory computer-readable medium of claim 18, wherein concatenating the first albedo-only view with the noised image in the height dimension comprises positioning the noised image above the first albedo-only view in the vertically concatenated input image.

20. The non-transitory computer-readable medium of claim 15, wherein the operations further comprise further adjusting the parameters of the diffusion neural network using distribution matching distillation.
